(19) United States
(12) Patent Application Publication
(10) Pub. No.: US 2008/0100163 A1
(43) Pub. Date: May 1, 2008

(54) Magnetic suspension with integrated motor

(76) Inventor: Allen Gary Storaasli, Federal Way, WA (US)

Correspondence Address: LAW OFFICE OF POLLY L. OLIVER, 3134 Parkside Circle NE, Tacoma, WA, 98422, US

(21) Appl. No.: 11/975,982

(22) Filed: Oct. 23, 2007

Related U.S. Application Data
(60) Provisional application No. 60/855,009, filed on Oct. 27, 2006.

(51) Int. Cl. H01F 7/08

(52) U.S. Cl. 310/90.5; 335/229

(57) ABSTRACT

A passive magnetic suspension acts as an electric motor with the introduction of lead means, such as motor windings, to harness and output the generated torque or voltage from the magnetic fields. The magnetic suspension consists of at least one magnetic element (typically a disc) fixed to a stator element (typically a shaft) and surrounded by two or more planetary magnets on the rotor. Having all magnet poles oriented in the same direction results in strong repulsion forces which provide the radial magnetic suspension. Segmenting the rotor magnet creates multiple unipolar magnetic fields, enabling additional possibilities in the introduction of windings to output the generated torque and provide motor function.

### RELATED APPLICATIONS

This application is related to and claims priority under 35 U.S.C. 119(e) to U.S. provisional application Ser. No. 60/855,009, entitled “Magnetic Suspension with Integrated Motor,” filed on Oct. 27, 2006, with inventor Allen Gary Storaasli, which is hereby incorporated by reference in its entirety.

### FIELD OF THE INVENTION

This invention pertains generally to suspension systems and more particularly to a rotary magnetic suspension system incorporating an integrated brushless DC motor that develops motor torque from fields between fixed coils and the orbiting magnet poles.

### BACKGROUND OF THE FIELD

Magnetic suspensions have been used to several advantages over ball or journal bearings—such as elimination of wear and friction. In fluid pump applications, magnetic bearings provide a clear flow path. In cryogenic applications, magnetic bearings can eliminate low temperature lubrication problems and material CTE problems. It is therefore desirable to provide a magnetic suspension of either passive or active type. In high speed energy storage flywheels and other gyro applications, magnetic suspensions eliminate friction, the need for lubrication, and overall life limitations.

In some previous applications with passive magnetic suspension, rotating torque has been provided by motors independent of the suspension. For instance, in U.S. Pat. No. 5,507,629 to R. Jarvik for artificial hearts, power is supplied to the rotary pump by means of an electric motor which may or may not be in physical proximity to the rotary pump itself. Obviously, this type of arrangement presents its own disadvantages.

In a different but related thread of previous applications, motors have been integrated with ‘active’ magnetic suspensions. The active magnetic suspension, such as the one disclosed in U.S. Pat. No. 6,320,290 to Kanebako, requires additional power and servo complexity; and the suspension is lost with power failure or servo malfunction.

In another thread of prior art patents, various magnetically balanced spinning apparatus are described. For instance, in U.S. Pat. No. 5,506,459 to Ritts, an upright rotating shaft assembly is balanced by circumscribing stator magnets. Ritts' device, however, is simply a display apparatus and does not provide motor function. Likewise, U.S. Pat. Nos. 4,382,245 and 5,182,533 disclose similar display apparatus. In U.S. Pat. No. 2,747,944 and others, a rotating shaft with permanent magnets provides bearing function for instruments and machines, but again, no motor function.

### SUMMARY OF THE INVENTION

The present invention solves the above-mentioned problems by demonstrating a passive magnetic suspension that can be used to act as or alternatively power an electric motor, a generator, or other device. The magnetic suspension consists of at least one magnetic element (typically a disc) fixed to a stator element (typically a shaft) and surrounded by two or more planetary magnets on the rotor. Having all magnet poles oriented in the same direction results in strong repulsion forces which provide the radial magnetic suspension. (This arrangement is in contrast to prior art which has one central disc and one exterior magnetic ring.) The plurality of planetary rotor magnets (which can also be seen as segmenting the rotor magnetic ring) creates multiple unipolar magnetic fields, enabling the introduction of windings to output the generated torque and provide motor function. The integrated motor function eliminates the addition of a separate motor.

### BRIEF DESCRIPTION OF THE DRAWINGS

FIG. 1 is a perspective view of a preferred embodiment of the magnetic suspension of the present invention;

FIG. 1A is a detail view of an alternate rotor axial end support;

FIG. 2A is a perspective view of a first alternate embodiment of the magnetic suspension using curved rotor magnets;

FIG. 2B is detail end view of a second alternate embodiment using curved rotor magnets and also having a soft iron ring for flux return;

FIG. 3A is a perspective view of an alternate embodiment of the magnetic suspension using split magnets;

FIG. 3B is a detail side view of a split magnet showing the coil inserted between the halves; and

FIG. 4 is a detail side view of an alternate embodiment of the magnetic suspension with coil placed within the radial gap between central and orbiting magnets.

### DETAILED DESCRIPTION

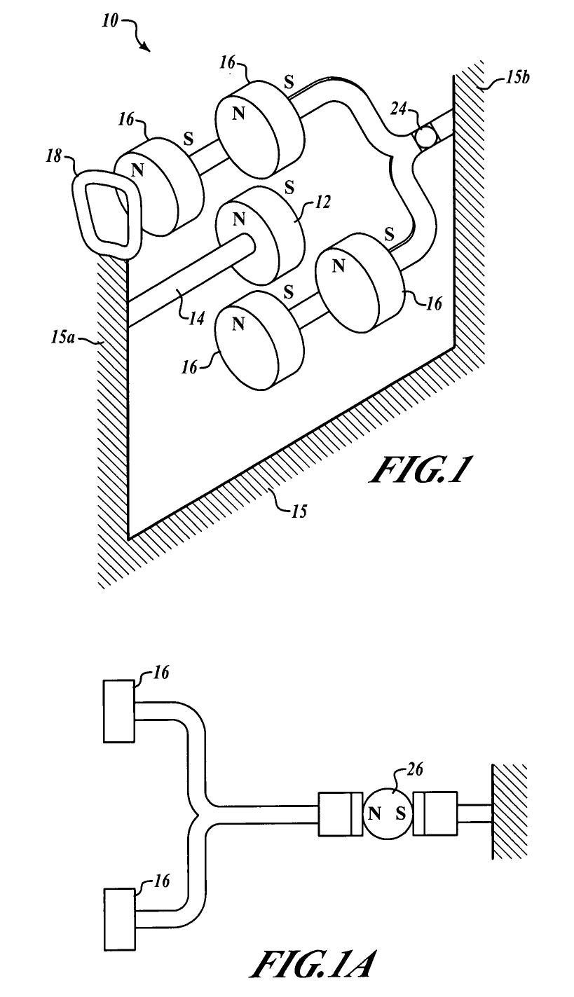

FIG. 1 shows how the magnetic suspension motor invention 10 may comprise at least one central stator magnetic element, here a disc, 12 fixed to a stator shaft 14 and surrounded by a plurality of planetary rotor magnets 16, generally coplanar therewith. At least two rotor magnets are recommended for stability; in this preferred embodiment, four have been used for the single stator magnet. Likewise, several stator magnets 12 could be used and spaced apart along an elongated stator shaft 14, each one having generally coplanar planetary rotor magnets. Each axially polarized dipole magnet (rotor or stator) has two poles designated as N or S (other designations could be used; however, N and S are typically used according to convention). Having all like magnet poles oriented in a common direction results in strong repulsion forces which provide the radial magnetic suspension. This arrangement is in contrast to prior art suspensions which comprise one central magnet disc surrounded by a magnetic ring instead of discrete magnets. In this embodiment, all N poles are oriented in a first direction, with all S poles oriented in a second direction. (Also, in prior art suspensions, the central magnetic elements rotate while the surrounding magnets are stationary.) In the proof of concept model, 0.75 inch diameter rare-earth magnets are used in all magnet positions—both stator and rotor.

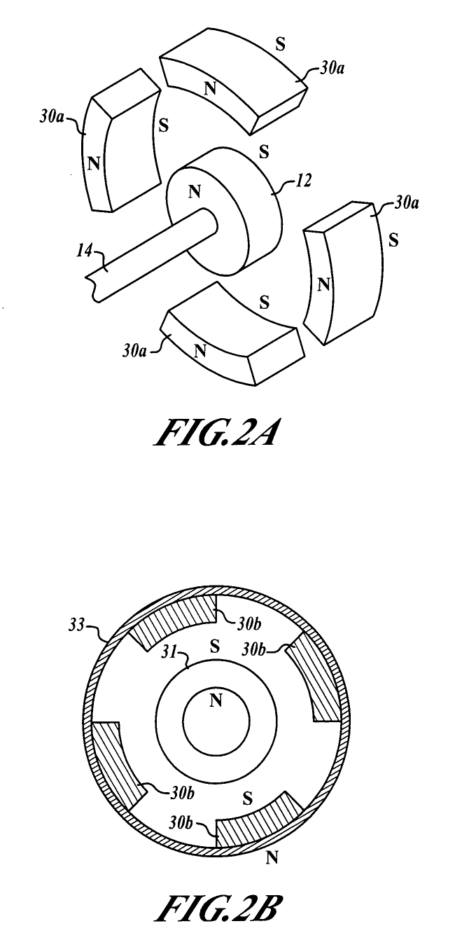

The plurality of discrete orbiting magnets (as opposed to the ring of the prior art) allows motor windings 18 to be inserted in close proximity to the orbiting rotor magnets 16 to harness the energy of the generated radial magnetic fields and transfer it as output torque or voltage, thereby allowing the magnetic suspension system to act as motor or generator. Other lead means could be used to transfer the generated torque; however, conventional copper windings have been used in this embodiment and the proof of concept model. The lead means, e.g., windings, could lead, for instance, to an output shaft. Such a motor may operate as a brushless, synchronous electric motor which, with slight adaptation, can be a stepper motor. In this preferred configuration, the motor windings 18 are fixed to the housing face 15a so as to be in close proximity to each rotor magnet as it passes the winding. In alternate configurations, the windings could be positioned differently in the axial and/or radial magnetic fields. Also in this preferred configuration, no soft iron flux return elements are used, and therefore the motor has no detent or cogging torque. Soft iron flux return elements (such as those shown in FIG. 2B) could be used to increase torque efficiency by providing flux return, however, may also introduce an attendant reduction in system efficiency (loss in radial suspension strength and cogging torque). If they are used, such soft iron flux return elements are located proximate the rotor magnets.

The stator shaft 14 is fixed to the housing 15 in a horizontal configuration, and the stator magnet is fixedly and axially attached thereto. (With little adaptation, the invention could be arranged so that the shaft 14 is held vertically.) The motor windings 18 may be held in place by linking to the housing 15 such that they are positioned as desired in proximity to the rotor magnets 16. Specifically, the windings 18 could be positioned adjacent the housing face 15a, which in this proof-of-concept model is generally orthogonal to the shaft 14, or could be positioned to extend from the housing 15 to be adjacent the rotor magnets and thereby further immersed in the magnetic fields.

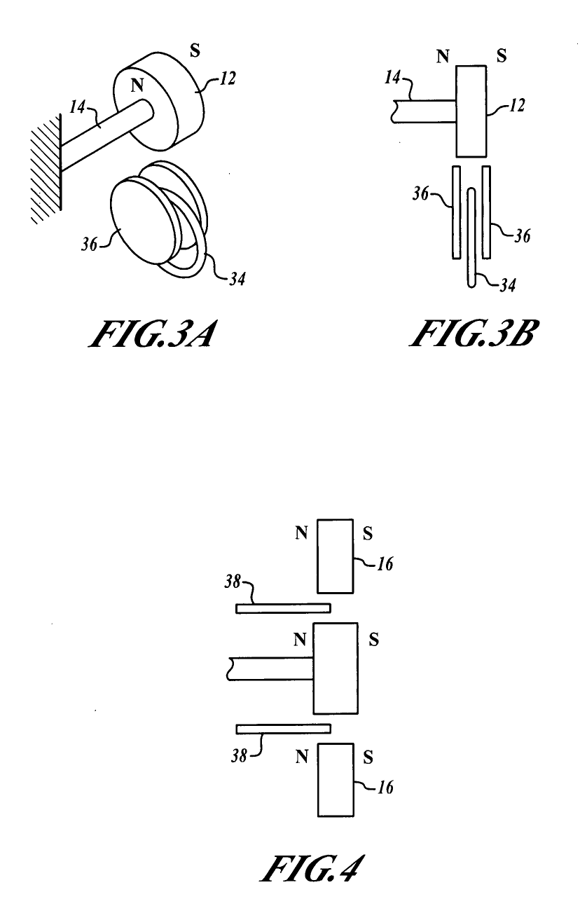

In FIG. 1 the motor windings are represented by a single winding element 18 (but it is understood that the windings may be divided into the conventional sine and cosine windings if desired) and are configured in an ‘axial field’ configuration. (Possible ‘radial field’ configurations are illustrated in FIGS. 3A, 3B, and 4.) In conventional motors of the axial field type, the orbiting magnet orientations should be alternated for best efficiency; however such alternation would reduce or even eliminate the magnetic suspension effect and so is not used here. In the proof of concept model, appropriately shaped copper coils (with resistance of 70 ohms) were placed near the rotor magnets (being mounted on the housing face 15a) to act as windings and demonstrate the motor function. Such windings are used to output the generated voltage from the magnetic fields. With such windings, the magnetic suspension can act as a brushless DC or other type of motor—or a generator. The motor voltage constant Kb was measured to be 0.02 volts/rad/sec, corresponding to 5 in-oz per amp. More efficiency may be gained by addition of more turns and more coils in the available spaces circumferentially.

The rotor end constraint 24 may be a ball bearing, and in the proof of concept model is an R4 size ball bearing. Such bearing provides axial and radial support and constraint but is quite flexible in terms of cross-axis stiffness. This type of end constraint offers minimal effect on the radial support within the suspension/motor. The rotor clearly supports itself in 1g environment and can be spun with no discernable cogging. The end constraint 24 being linked to the housing face 15b ensures that the magnetic suspension system 10 is constrained axially. The housing 15b is linked to the housing face 15a, both 15a and 15b being associated parts of the overall housing 15.

FIG. 1A shows a magnetic sphere 26 being used as the end support instead of the ball bearing of the preferred embodiment. Magnetic sphere 26 provides strong axial support in the “compressive” direction and weaker axial support in the “tensile” direction. In the radial direction it is self-centering, giving radial magnetic support.

The curved rotor magnets 30a of FIG. 2A may replace the circular disc magnets 16 surrounding the stator magnet 12. In this alternate embodiment, the rotor magnets 30a are magnetized and polarized axially, as they are in the previous figures. Such curved magnets 30a may improve motor torque and magnetic suspension performance, but at the same time may introduce manufacturing complexity. Note that for this embodiment, as few as two orbiting magnets may be used to accomplish radial suspension as well as enabling motor function. A soft iron circumferential sleeve (as in FIG. 2B) may be added to improve motor performance. Alternatively, FIG. 2B shows use of curved rotor magnets 30b which are magnetized and polarized radially. In this case, the stator magnet 31 is also radially magnetized. Regardless of whether the N or S pole is directed outward, the magnetic field is created by positioning repulsive forces adjacent each other (as are the S poles in the figure). The windings may be located in close proximity to the inside diameter of the rotor segments. A soft iron circumferential sleeve 33 in this figure is used to improve motor performance. In further alternative embodiments, the magnetic elements may also be stacked or spaced axially to suit the application.

Another way to improve torque efficiency may be to insert the coil windings 34 between polarities (N and S) of split rotor magnets 36 as shown in FIG. 3A. FIG. 3B is a side view of a possible configuration of the split magnet configuration. In these figures, the windings are shown as having circular shape. However, it is understood that the windings may be of any appropriate shape, and indeed it is well-known that the shape of the winding—especially the length of [copper] wire used—may effect the efficiency of the overall system. FIG. 4 shows how the windings 38, or a portion thereof, may be placed within the radial gap between the central magnet on the stator and the orbiting rotor magnets 16, thereby employing at least partially a radial field configuration. In this case, the windings may be positioned at generally 45 degrees-recommended for use with 4 rotor magnets. Additional motor windings may be positioned at different locations for different functions.

What is claimed is:

1. A magnetic suspension comprising a fixed stator shaft extending from a housing with at least one central magnetic element fixed axially thereon, said central magnetic element having two poles designated N and S with the N pole oriented in a first direction; a plurality of planetary rotor magnets surrounding and generally coplanar with each of said at least one central magnetic element, said rotor magnets each having two poles designated N and S with the N poles oriented in said first direction; said rotor magnets being supported axially by an end constraint linked to said housing, said constraint to be chosen for minimal effect on the radial support within the suspension.

2. The magnetic suspension of claim 1 wherein said magnetic elements and said magnets are comprised of axially polarized discs.

3. The magnetic suspension of claim 1 wherein said magnetic elements and said magnets are comprised of axially polarized curved magnets.

4. The magnetic suspension of claim 1 wherein said magnetic elements and said magnets are comprised of radially polarized curved magnets.

5. The magnetic suspension of claim 2 further comprising soft iron flux return elements proximate said rotor magnets.

6. The magnetic suspension of claim 3 further comprising a soft iron circumferential sleeve proximate said rotor magnets.

7. The magnetic suspension of claim 4 further comprising a soft iron circumferential sleeve proximate said rotor magnets.

8. The magnetic suspension of claim 1 further comprising motor windings in close proximity to at least one of said rotor magnets, said windings being configured in the axial field.

9. The magnetic suspension of claim 1 further comprising motor windings in close proximity to at least one of said rotor magnets, said windings being configured in the radial field.

10. The magnetic suspension of claim 8 wherein at least one of said rotor magnets is split into polarized portions and motor windings are located between the polarized portions to output the magnetically generated torque.

11. The magnetic suspension of claim 8 wherein said motor windings are located between said central stator magnet and said rotor magnets.

12. A magnetic suspension comprising a stator magnet and a plurality of planetary, axially constrained rotor magnets orbiting said stator magnet, said stator and rotor magnets having like poles oriented in a common direction.

13. The magnetic suspension of claim 12 further comprising motor windings located proximate said rotor magnets.

14. The magnetic suspension of claim 13 further comprising at least one soft iron flux return element located proximate said rotor magnets for providing flux return to improve motor performance.

15. The magnetic suspension of claim 13 wherein said motor windings are used to output the generated voltage so that said magnetic suspension acts as a brushless DC motor.

16. The magnetic suspension of claim 13 wherein said motor windings are used to output the generated voltage so that said magnetic suspension acts as a generator.

17. An electric motor comprising a housing with stator shaft fixedly attached thereto, a stator magnet fixedly and axially attached to said stator shaft, a plurality of axially constrained rotor magnets orbiting said stator magnet to create a radial magnetic field for generating torque.

18. The electric motor of claim 17 wherein said stator and rotor magnets have like poles oriented in a common direction.

19. The electric motor of claim 18 further comprising lead means for transferring torque from said radial magnetic field to an output shaft.

20. The electric motor of claim 19 wherein said lead means comprise motor windings located in proximity to said rotor magnets.
